(19) United States
(12) Patent Application Publication
(10) Pub. No.: US 2023/0106534 A1
(43) Pub. Date: Apr. 6, 2023

(54) INFORMATION INTERACTION METHOD, APPARATUS, ELECTRONIC DEVICE, AND READABLE STORAGE MEDIUM

(71) Applicant: BEIJING DIDI INFINITY TECHNOLOGY AND DEVELOPMENT CO., LTD., Beijing (CN)

(72) Inventors: Linxiang QIU, Beijing (CN); Qianhong CHEN, Beijing (CN)

(73) Assignee: BEIJING DIDI INFINITY TECHNOLOGY AND DEVELOPMENT CO., LTD., Beijing (CN)

(21) Appl. No.: 18/063,649

(22) Filed: Dec. 8, 2022

Related U.S. Application Data
(63) Continuation of application No. PCT/CN2021/105527, filed on Jul. 9, 2021.

(30) Foreign Application Priority Data
Jul. 15, 2020 (CN) 202010682958.9

(51) Int. Cl. G01C 21/34; G01C 21/36

(52) U.S. Cl. CPC G01C 21/3438; G01C 21/3626

(57) ABSTRACT

The present disclosure may provide an information interaction method, apparatus, electronic device, and readable storage medium relating to the field of computer technology. The method may include: in response to monitoring that an expected pick-up location is within a preset coordinate range, displaying at least one pick-up area within the preset coordinate range, wherein the expected pick-up location is a coordinate point of a map; receiving a pick-up area selecting instruction, and determining a target pick-up area; determining a target pick-up location corresponding to the target pick-up area; determining a recommended route between a current location and the target pick-up location in response to receiving a submitting instruction for the target pick-up location; based on the recommended route, displaying route guidance information.

### CROSS-REFERENCE TO RELATED APPLICATIONS

This application is a continuation of International Patent Application No. PCT/CN2021/105527, filed on Jul. 9, 2021, which claims priority to Chinese Patent Application No. 202010682958.9, filed on Jul. 15, 2020, the entire contents of each of which are hereby incorporated by reference.

### TECHNICAL FIELD

The present disclosure relates to the field of computer technology, and in particular, to an information interaction method, apparatus, electronic device, and readable storage medium.

### BACKGROUND

At present, online car hailing has become one of the main ways for people to travel. When a user uses a car-hailing service of an online car-hailing software, a pick-up location and a destination need to be determined first, and then an order is submitted.

In the prior art, an electronic device may determine its geographic location based on a satellite positioning technology, and then automatically recommend the pick-up location to the user according to the geographic location.

However, when the user is in a low-frequency and complex car usage scene (such as an airport, a train station, etc.), the pick-up location automatically recommended by the electronic device may be not necessarily the most preferred, and it may be necessary for the user to manually select the pick-up location again, thereby reducing the efficiency of information interaction with the user of the electronic device.

### SUMMARY

In view of this, the present disclosure may provide an information interaction method, apparatus, electronic device, and readable storage medium.

In a first aspect, an information interaction method may be provided. The method may be applied to an electronic device. The method may include:

in response to monitoring that an expected pick-up location is within a preset coordinate range, displaying at least one pick-up area within the preset coordinate range, wherein the expected pick-up location is a coordinate point of a map;

receiving a pick-up area selecting instruction, and determining a target pick-up area;

determining a target pick-up location corresponding to the target pick-up area;

determining a recommended route between a current location and the target pick-up location in response to receiving a submitting instruction for the target pick-up location; and

based on the recommended route, displaying route guidance information.

Optionally, each of the at least one pick-up area may include at least one pick-up sub-area;

the displaying the at least one pick-up area within the preset coordinate range may include:

displaying the at least one pick-up area within the preset coordinate range and the at least one pick-up sub-area in each pick-up area.

Optionally, the displaying the at least one pick-up area within the preset coordinate range and the at least one pick-up sub-area in each pick-up area may include:

displaying the preset coordinate range in a map area of a display interface, and displaying the at least one pick-up area and the at least one pick-up sub-area in each pick-up area in a list area of the display interface.

Optionally, the displaying the preset coordinate range in the map area of the display interface may include:

rendering the at least one pick-up sub-area in each pick-up area with a preset color and displaying the rendered at least one pick-up area on the map area of the display interface.

Optionally, the determining the target pick-up location corresponding to the target pick-up area may include:

receiving a pick-up sub-area selecting instruction, and determining a target pick-up sub-area;

determining at least one to-be-determined pick-up location corresponding to the target pick-up area; and

determining the target pick-up location in the at least one to-be-determined pick-up location.

Optionally, the determining the target pick-up location in the at least one to-be-determined pick-up location may include:

in response to the target pick-up sub-area having one to-be-determined pick-up location, determining that the to-be-determined pick-up location is the target pick-up location;

in response to the target pick-up sub-area having multiple to-be-determined pick-up locations, determining one to-be-determined pick-up location of the multiple to-be-determined pick-up locations as the target pick-up location.

Optionally, the determining one to-be-determined pick-up location of the multiple to-be-determined pick-up locations as the target pick-up location may include:

determining a passenger flow density of each of the multiple to-be-determined pick-up locations, wherein the passenger-flow density is used to characterize a count of people waiting to be picked up at the to-be-determined pick-up location;

determining a to-be-determined pick-up location with a smallest passenger flow density as the target pick-up location.

Optionally, the displaying the route guidance information based on the recommended route may include at least one of:

based on the recommended route, displaying a graphic-text walking guidance information window on the display interface, wherein the graphic-text walking guidance information window includes text guidance information and image guidance information;

based on the recommended route, displaying an augmented reality walking guidance window on the display interface, wherein the augmented reality walking guidance window includes an environment image collected in real-time by a terminal and a guidance sign rendered and displayed on the environment image; or

based on the recommended route, displaying a guide window for service usage of a pick-up personnel at airport, wherein the guide window for the service usage of the pick-up personnel at airport includes appearance description information of the pick-up personnel and location information of the pick-up personnel.

In a second aspect, an information interaction apparatus may be provided. The apparatus may be applied to an electronic device and include:

a pick-up area display module configured to, in response to monitoring that an expected pick-up location is within a preset coordinate range, display at least one pick-up area within the preset coordinate range, wherein the expected pick-up location is a coordinate point of a map;

a pick-up area determination module configured to receive a pick-up area selecting instruction, and determine a target pick-up area;

a target pick-up location determination module configured to determine a target pick-up location corresponding to the target pick-up area;

a recommended route determination module configured to determine a recommended route between a current location and the target pick-up location in response to receiving a submitting instruction for the target pick-up location;

a guidance information display module configured to display route guidance information based on the recommended route.

Optionally, each of the at least one pick-up area may include at least one pick-up sub-area;

the pick-up area display module may be configured to:

display the at least one pick-up area within the preset coordinate range and the at least one pick-up sub-area in each pick-up area.

Optionally, the pick-up area display module may be further configured to:

display the preset coordinate range in a map area of a display interface, and display the at least one pick-up area and the at least one pick-up sub-area in each pick-up area in a list area of the display interface.

Optionally, the pick-up area display module may be further configured to:

render the at least one pick-up sub-area in each pick-up area with a preset color and display the rendered at least one pick-up sub-area on the map area of the display interface.

Optionally, the target pick-up location determination module may be configured to:

receive a pick-up sub-area selecting instruction, and determine a target pick-up sub-area;

determine at least one to-be-determined pick-up location corresponding to the target pick-up area;

determine the target pick-up location in the at least one to-be-determined pick-up location.

Optionally, the target pick-up location determination module may be further configured to:

in response to the target pick-up sub-area having one to-be-determined pick-up location, determine that the to-be-determined pick-up location is the target pick-up location;

in response to the target pick-up sub-area having multiple to-be-determined pick-up locations, determine one to-be-determined pick-up location among the multiple to-be-determined pick-up locations as the target pick-up location.

Optionally, the target pick-up location determination module may be further configured to:

determine a passenger flow density of each of the multiple to-be-determined pick-up locations, wherein the passenger-flow density is used to characterize a count of people waiting to be picked up at the to-be-determined pick-up location;

determine a to-be-determined pick-up location with a smallest passenger flow density as the target pick-up location.

Optionally, the guidance information display module may be configured to perform at least of:

based on the recommended route, displaying a graphic-text walking guidance information window on the display interface, wherein the graphic-text walking guidance information window includes text guidance information and image guidance information;

based on the recommended route, displaying an augmented reality walking guidance window on the display interface, wherein the augmented reality walking guidance window includes an environment image collected in real-time by a terminal and a guidance sign rendered and displayed on the environment image; or

based on the recommended route, displaying a guide window for service usage of a pick-up personnel at airport, wherein the guide window for the service usage of the pick-up personnel at airport includes appearance description information of the pick-up personnel and location information of the pick-up personnel.

In a third aspect, the present disclosure may provide an electronic device. The electronic device may include a storage and a processor. The storage may be configured to store one or more computer program instructions. The one or more computer program instructions may be executed by the processor to implement the method of the first aspect.

In a fourth aspect, the present disclosure may provide a non-transitory computer-readable storage medium comprising a set of instructions, wherein when executed by a processor, the method of the first aspect may be implemented.

Through some embodiments of the present disclosure, the electronic device can display all pick-up areas. A user can freely choose the target pick-up location without being forcibly recommended to a target pick-up location, which increases the diversity of choices. At the same time, since the user can independently select the pick-up area, the interaction efficiency between the electronic device and the user on the side of the electronic device may be improved, and the user experience may be improved.

### BRIEF DESCRIPTION OF THE DRAWINGS

The above-mentioned and other objects, features, and advantages of the present disclosure may become more apparent from the following description of the embodiments of the present disclosure with reference to the accompanying drawings, in which:

FIG. 1 is a flowchart illustrating an information interaction method according to some embodiments of the present disclosure;

FIG. 2 is a schematic diagram illustrating a display interface of an electronic device according to some embodiments of the present disclosure;

FIG. 3 is a schematic diagram illustrating another display interface of an electronic device according to some embodiments of the present disclosure;

FIG. 4 is a schematic diagram illustrating another display interface of an electronic device according to some embodiments of the present disclosure;

FIG. 5 is a flowchart illustrating another information interaction method according to some embodiments of the present disclosure;

FIG. 6 is a schematic diagram illustrating another display interface of an electronic device according to some embodiments of the present disclosure;

FIG. 7 is a schematic diagram illustrating another display interface of an electronic device according to some embodiments of the present disclosure;

FIG. 8 is a schematic diagram illustrating another display interface of an electronic device according to some embodiments of the present disclosure;

FIG. 9 is a schematic diagram illustrating another display interface of an electronic device according to some embodiments of the present disclosure;

FIG. 10 is a flowchart illustrating another information interaction method according to some embodiments of the present disclosure;

FIG. 11 is a schematic diagram illustrating a structure of an information interaction apparatus according to some embodiments of the present disclosure; and

FIG. 12 is a schematic diagram illustrating a structure of an electronic device according to some embodiments of the present disclosure.

### DETAILED DESCRIPTION

The present disclosure may be described below based on embodiments. However, the present disclosure may be not limited to these embodiments only. In the following detailed description of the present disclosure, some specific details may be described in detail. Those skilled in the art may fully understand the present disclosure without the description of these detailed parts. Well-known methods, processes, procedures, components, and circuits have not been described in detail in order to avoid obscuring the essence of this present disclosure.

Furthermore, those skilled in the art may appreciate that the drawings provided herein are for illustrative purposes and are not necessarily drawn to scale.

Unless clearly required by the context, terms such as “including,” “comprising,” or the like in the present disclosure should be construed in an inclusive sense rather than an exclusive or exhaustive sense; that is, the terms mean “including but being not limited to.”

In the description of the present disclosure, it should be understood that terms “first,” “second,” or the like may be used for descriptive purposes only, and should not be construed as indicating or implying relative importance. Also, in the description of this present disclosure, unless otherwise specified, “multiple” may mean two or more.

The present disclosure may provide an information interaction method. The method may be applied to an electronic device. The electronic device may be a mobile terminal (such as a smart phone, a tablet computer, a smart watch, etc.) or a personal computer (PC) terminal.

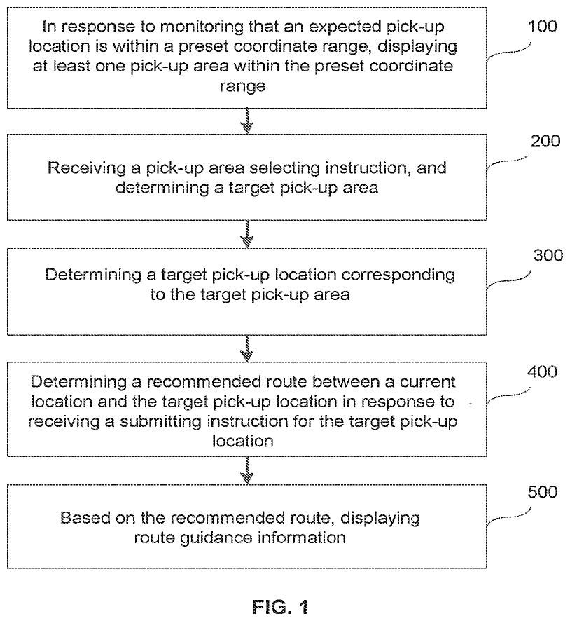

An information interaction method according to some embodiments of the present disclosure may be described in detail below with reference to the specific implementation manner. As shown in FIG. 1, the specific steps may be as follows:

Step 100, in response to monitoring that an expected pick-up location is within a preset coordinate range, displaying at least one pick-up area within the preset coordinate range.

Wherein, the expected pick-up location is a coordinate point of a map.

Step 200, receiving a pick-up area selecting instruction, and determining a target pick-up area.

Step 300, determining a target pick-up location corresponding to the target pick-up area.

Step 400, determining a recommended route between a current location and the target pick-up location in response to receiving a submitting instruction for the target pick-up location.

Step 500, based on the recommended route, displaying route guidance information.

Through some embodiments of the present disclosure, the electronic device can display all pick-up areas. A user can freely choose the target pick-up location without being forced to be recommended to a target pick-up location, which increases the diversity of choices. At the same time, since the user can independently select the pick-up area, the interaction efficiency between the electronic device and the user on the side of the electronic device may be improved, and the user experience may be improved.

Further, some embodiments of the present disclosure may provide two scenarios as examples for illustration, and the two scenarios may include a simple scenario and a complex scenario.

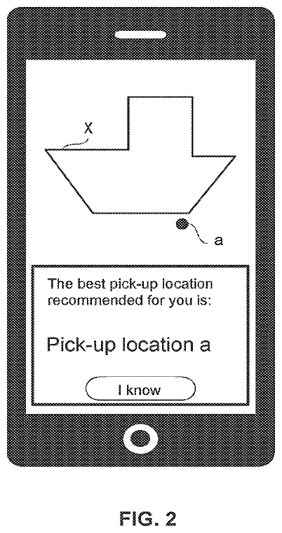

Specifically, for a simple scenario, as shown in FIG. 2, FIG. 2 is a schematic diagram illustrating a display interface of an electronic device according to some embodiments of the present disclosure. The schematic diagram may include: a map area and a pop-up window for pick-up confirmation.

The map area may include: a preset coordinate range X and a pick-up location 1. The pop-up window for pick-up confirmation may include: target pick-up location information and an “I know” button.

It should be noted that, in some embodiments of the present disclosure, the simple scenario may be that there is only one pick-up area within the preset coordinate range, and the pick-up area only includes one pick-up location. Therefore, the pop-up window for pick-up confirmation in FIG. 2 may display the unique pick-up location within the preset coordinate range of the simple scenario.

In this scenario, when the electronic device monitors that the expected pick-up location is within the preset coordinate range X, the electronic device may display the content shown in FIG. 2 on the display interface. Since this scenario is the simple one, when the user clicks the “I know” button, it may mean that the user wants to be picked up within the preset coordinate range X shown in FIG. 2. The electronic device may directly determine the pick-up location 1 as the target pick-up location, and recommend and display the guidance information for the user based on the pick-up location 1.

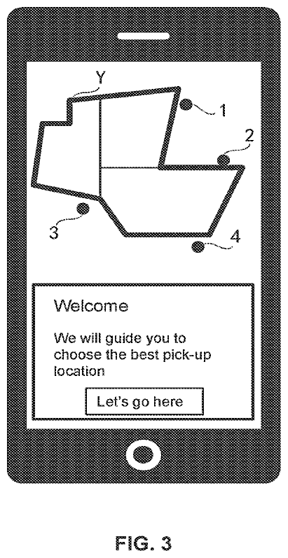

For a complex scenario, as shown in FIG. 3, FIG. 3 is a schematic diagram illustrating another display interface of an electronic device according to some embodiments of the present disclosure. The schematic diagram may include: a map area and a pop-up window for pick-up confirmation.

The map area may include: a preset coordinate range Y (an area indicated by the bold solid line), a pick-up location 1, a pick-up location 2, a pick-up location 3, and a pick-up location 4. The pop-up window for pick-up confirmation may include: a welcome message and a “Let's go here” button.

It should be noted that, in some embodiments of the present disclosure, the complex scenario may be that there are at least two pick-up locations within the preset coordinate range.

For example, the preset coordinate range Y in FIG. 3 may include four pick-up locations, so the scenario shown in FIG. 3 may be the complex scenario.

As another example, in scenario A, there may be a pick-up area a within the preset coordinate range. There may be two pick-up locations in the pick-up area a. The scenario A may be the complex scenario.

As another example, in scenario B, there may be a pick-up area b and a pick-up area c within the preset coordinate range. There may be a pick-up location in the pick-up area b, and a pick-up location in the pick-up area c. The scenario b may also be the complex scenario.

In this scenario, when the electronic device monitors that the expected pick-up location is within the preset coordinate range Y, the electronic device may display the content shown in FIG. 3 on the display interface. When the user clicks the “Let's go here” button, it means that the user wants to be picked up within the preset coordinate range Y, and then the electronic device may continue to perform the above steps 200 to 500.

Optionally, each of the at least one pick-up area may include at least one pick-up sub-area. In step 100, the displaying the at least one pick-up area within the preset coordinate range may specifically be performed as: displaying the at least one pick-up area within the preset coordinate range and the at least one pick-up sub-area in each pick-up area.

Specifically, the electronic device may display the preset coordinate range in the map area of the display interface, and display the at least one pick-up area and the at least one pick-up sub-area in each pick-up area in a list area of the display interface.

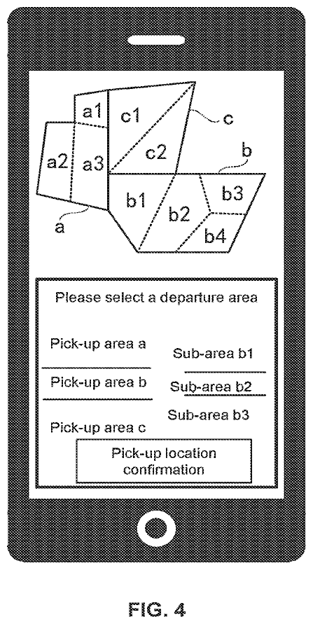

For example, as shown in FIG. 4, FIG. 4 is a schematic diagram illustrating another display interface of an electronic device according to some embodiments of the present disclosure. The schematic diagram may include: a map area and a list area.

The map area may show a pick-up area a, a pick-up area b, and a pick-up area c. The pick-up area a may include a pick-up sub-area a1, a pick-up sub-area a2, and a pick-up sub-area a3. The pick-up area b may include a pick-up sub-area b1, a pick-up sub-area b2, a pick-up sub-area b3, and a pick-up sub-area b4. The pick-up area c may include a pick-up sub-area c1 and a pick-up sub-area c2.

The list area may include: a “please select departure area” reminder, a pick-up area selection list, a pick-up sub-area selection list, and a “pick-up location confirmation” button.

In combination with the content shown in FIG. 3, when the user clicks the “Let's go here” button in FIG. 3, the electronic device may display the interface shown in FIG. 4.

It should be noted that in practical applications, due to the limited size of the display interface of the electronic device, only part of the pick-up areas or part of the pick-up sub-areas may be displayed in the list area. In FIG. 4, due to the limited size of the list area, only the pick-up sub-areas of the pick-up area b may be displayed. The pick-up sub-areas of the pick-up area a and the pick-up area c may be not displayed.

Moreover, the pick-up area b may include the pick-up sub-area b1, the pick-up sub-area b2, the pick-up sub-area b3, and the pick-up sub-area b4. Since there are too many sub-areas in the pick-up area b, only the pick-up sub-area b1, the pick-up sub-area b2, and the pick-up sub-area b3 may be displayed in a sub-area list.

Optionally, in combination with the content shown in FIG. 4, the electronic device may render the at least one pick-up sub-area in each pick-up area with a preset color and display thereof on the map area of the display interface.

For example, in FIG. 4, the electronic device may render the pick-up sub-areas a1, a2, a3, b1, b2, b3, b4, c1, and c2 in different colors, respectively, then display them in the map area, so that each pick-up area may be more clearly displayed in the map area.

Through some embodiments of the present disclosure, the electronic device may display the pick-up area(s) and the pick-up sub-area(s) in the form of images in the map area of the display interface. The electronic device may also display the pick-up area(s) and the pick-up sub-area(s) in the form of text in the list area of the display interface. Each pick-up area and each pick-up sub-area of each pick-up area may be more intuitively and effectively distinguished by combining the two display forms.

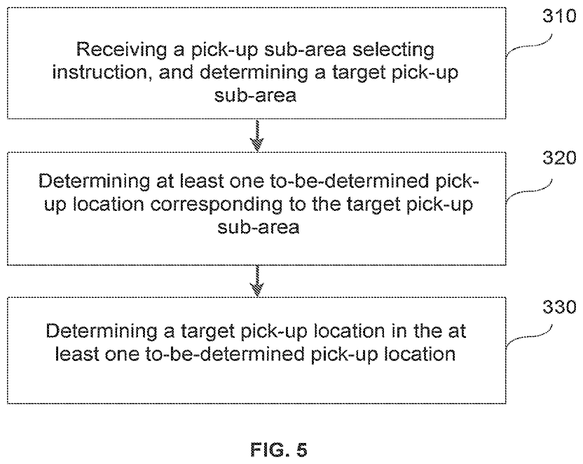

Optionally, as shown in FIG. 5, step 300 may specifically include the following steps:

Step 310, receiving a pick-up sub-area selecting instruction, and determining a target pick-up sub-area.

For example, the user may select the desired target pick-up area by sliding options in the list area. In FIG. 4, the target pick-up area may be the pick-up area b2. The user may click the “pick-up location confirmation” button, so that the electronic device determines the target pick-up area as the pick-up area b2.

Step 320, determining at least one to-be-determined pick-up location corresponding to the target pick-up sub-area.

In a complex scenario, such as in an airport terminal area, there may be few parking spots available for drivers to park. Therefore, in the target pick-up sub-area, there may be only one to-be-determined pick-up location, or multiple to-be-determined pick-up locations.

Step 330, determining the target pick-up location among the at least one to-be-determined pick-up location.

Optionally, step 320 may specifically include:

Case 1: in response to the target pick-up sub-area having one to-be-determined pick-up location, determining that the to-be-determined pick-up location is the target pick-up location.

Case 2: in response to the target pick-up sub-area having multiple to-be-determined pick-up locations, determining one to-be-determined pick-up location of the multiple to-be-determined pick-up locations as the target pick-up location.

Optionally, for case 2, the electronic device may specifically perform the following steps: determining a passenger flow density of each to-be-determined pick-up location, and determining a to-be-determined pick-up location with a smallest passenger flow density as the target pick-up location.

As used herein, the passenger-flow density is used to characterize a count of people waiting to be picked up at the to-be-determined pick-up location.

For example, in combination with the content shown in FIG. 4, if the user chooses to be picked up at the pick-up sub-area b2 in the pick-up area b, and the pick-up sub-area b2 includes three to-be-determined pick-up locations (a pick-up location x, a pick-up location y, and a pick-up location z), the electronic device may determine the passenger flow densities of the three to-be-determined pick-up locations, respectively.

If there are three waiting passengers at the pick-up location x, five waiting passengers at the pick-up location y, and one waiting passenger at the pick-up location z, the pick-up location z with the smallest passenger flow density may be the to-be-determined pick-up location.

Further, the electronic device may determine the pick-up location z as the target pick-up location, determine a recommended route based on the pick-up location z, and display route guidance information on the recommended route.

Through some embodiments of the present disclosure, according to the passenger flow density of each to-be-determined pick-up location, the electronic device may determine the to-be-determined pick-up location with the smallest passenger flow density as the target pick-up location, which enables each user to go to the pick-up location with the smallest passenger flow density in the target pick-up area, thereby reducing a crowded situation in a complex scenario.

Optionally, for the electronic device to display the route guidance information, step 500 may include at least one of the following steps:

Step A, based on the recommended route, displaying a graphic-text walking guidance information window on the display interface.

As used herein, the graphic-text walking guidance information window may include text guidance information and image guidance information.

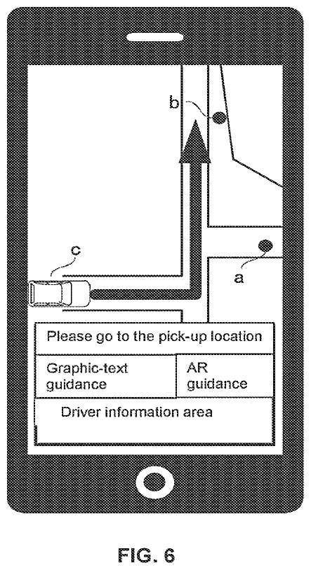

As shown in FIG. 6, FIG. 6 is a schematic diagram illustrating another display interface of an electronic device according to some embodiments of the present disclosure. The schematic diagram may include: a map area, a driver information area, and a guidance information selection window.

The map area may include: a current location a, a target pick-up location b, a driver's location c, and a route that the driver comes to the target pick-up location b. The guidance information selection window may include: a “please go to the pick-up location” slogan, a “graphic-text guidance” button, and an “AR guidance” button.

In some embodiments of the present disclosure, after the user clicks the “graphic-text guidance” button, the electronic device may perform step A.

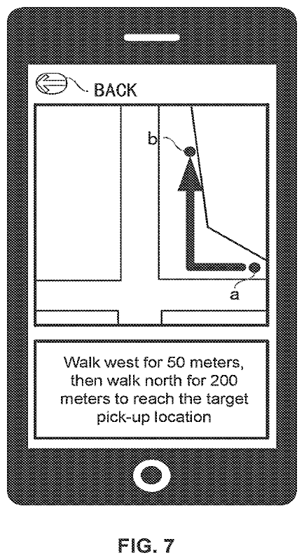

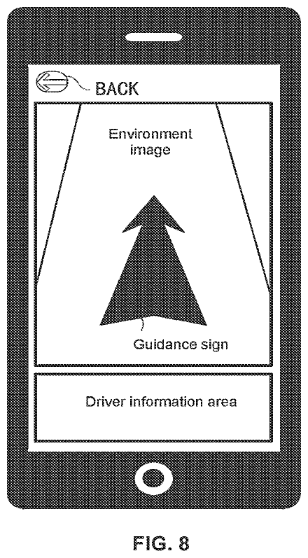

Further, as shown in FIG. 7, FIG. 7 is a schematic diagram illustrating another display interface of an electronic device according to some embodiments of the present disclosure. The schematic diagram may include: a map area, a graphic-text walking guidance information window, and a “back” button.

In combination with the content shown in FIG. 6, when the user clicks the “graphic-text guidance” button, the electronic device may display the display interface shown in FIG. 7.

The map area may include: a current location a and a target pick-up location b. The graphic-text walking guidance information window may include: an image area and a text area. The image area may display image guidance information. The text area may display text guidance information. The user may go to the target pick-up location by himself or herself according to a map guidance arrow in the image area and the guidance text in the text area.

After the user clicks the “back” button in FIG. 7, the display interface of the electronic device may be switched to the interface shown in FIG. 6.

Step B, based on the recommended route, displaying an augmented reality (AR) walking guidance window on the display interface.

The augmented reality walking guidance window may include an environment image collected in real-time by a terminal and a guidance sign rendered and displayed on the environment image.

As shown in FIG. 8, FIG. 8 is a schematic diagram illustrating another display interface of an electronic device according to some embodiments of the present disclosure. The schematic diagram may include: an augmented reality walking guidance window and a “back” button.

In combination with the content shown in FIG. 6, when the user clicks the “AR guidance” button, the electronic device may display the display interface shown in FIG. 8.

The augmented reality walking guidance window may include: an environment image and a guide sign. The user may intuitively see the travel route to the target pick-up location according to the environment image collected in real-time by the terminal and the guide sign rendered and displayed on the environment image, and then walk to the target pick-up location according to the travel route.

After the user clicks the “back” button in FIG. 8, the display interface of the electronic device may be switched to the interface shown in FIG. 6.

Operation C, based on the recommended route, displaying a guidance window for service usage of a pick-up personnel at airport.

The guidance window for the service usage of the pick-up personnel at airport may include appearance description information of the pick-up personnel and location information of the pick-up personnel.

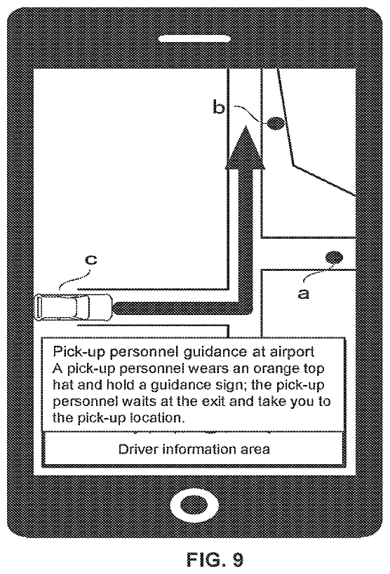

As shown in FIG. 9, FIG. 9 is a schematic diagram illustrating another display interface of an electronic device according to some embodiments of the present disclosure. The schematic diagram may include: a map area, a driver information area, and a guidance window for service usage of a pick-up personnel at airport.

The map area may include: a current location a, a target pick-up location b, a driver's location c, and a route that the driver comes to the target pick-up location b. The user may quickly find the pick-up personnel by using the appearance description information and the location information of the pick-up personnel according to the guidance window for the service usage of the pick-up personnel at airport. Then the pick-up personnel may lead the user to the target pick-up location.

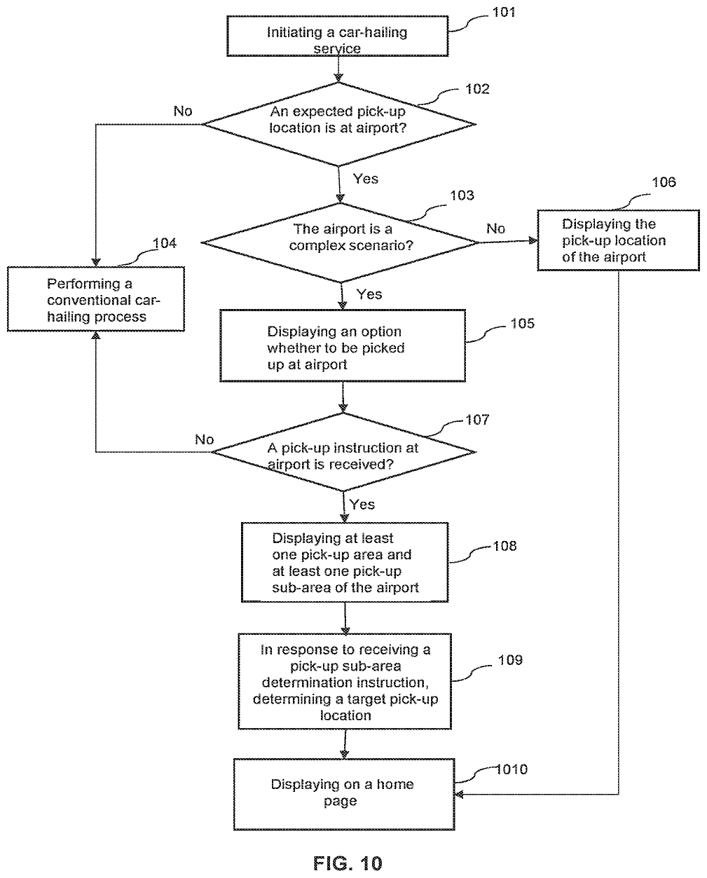

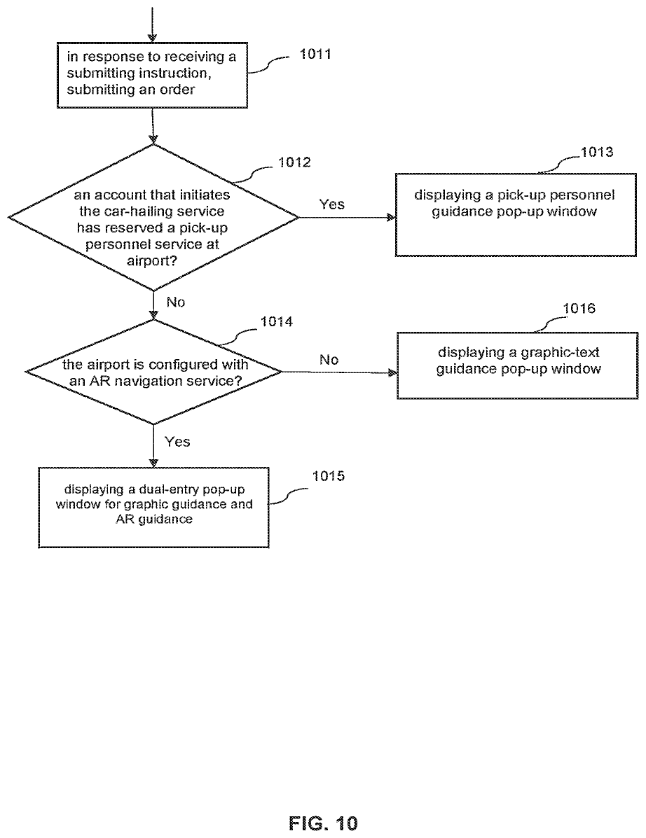

As shown in FIG. 10, FIG. 10 is a flowchart illustrating an information interaction method according to some embodiments of the present disclosure. The flowchart may take an airport scenario as an example, and the specific steps may be as follows:

Step 101, initiating a car-hailing service.

In practical applications, when an electronic device initiates the car-hailing software, the car-hailing service may be initiated.

Step 102, determining whether an expected pick-up location is at airport, in response to the expected pick-up location being at airport, performing step 103, and in response to the expected pick-up location not being at airport, performing step 104.

Step 103, determining whether the airport is a complex scenario, and in response to the airport being the complex scenario, performing step 105, and in response to the airport being a simple scenario, performing step 106.

Step 104, performing a conventional car-hailing process.

Step 105, displaying an option whether to be picked up at airport.

Specifically, the interface of the electronic device displaying the option whether to pick up at airport is shown in FIG. 3.

Step 106, displaying the pick-up location of the airport.

Specifically, an interface of the electronic device may display pick-up location(s) of the airport as shown in FIG. 2.

It should be noted that after the user clicks the “I know” button in the interface shown in FIG. 2, the electronic device may perform step 1010.

Step 107, determining whether a pick-up instruction at airport is received, and in response to receiving the pick-up instruction at airport, performing step 108, and in response to not receiving the pick-up instruction at airport, performing step 104.

Step 108, displaying at least one pick-up area and at least one pick-up sub-area of the airport.

Specifically, the interface of the electronic device may display the at least one pick-up area and the at least one pick-up sub-area of the airport as shown in FIG. 4.

Step 109, in response to receiving a pick-up sub-area determination instruction, determining a target pick-up location.

Step 1010, displaying on a home page.

Step 1011, in response to receiving a submitting instruction, submitting an order.

In practical applications, the user may click an “order confirmation” button on the display interface of the electronic device. The electronic device may send a task order to the car-hailing driver, that is, the order is submitted.

Step 1012, determining whether an account that initiates the car-hailing service has reserved a pick-up personnel service at airport, and in response that the account that initiates the car-hailing service has reserved the pick-up personnel service at airport, performing step 1013, in response that the account that initiates the car-hailing service has not reserved the pick-up personnel service at airport, performing step 1014.

Step 1013, displaying a pick-up personnel guidance pop-up window.

Specifically, the interface of the electronic device may display the pick-up personnel guidance pop-up window as shown in FIG. 9.

Step 1014, determining whether the airport is configured with an AR navigation service, in response to the airport is configured with the AR navigation service, performing step 1015, in response to the airport is not configured with the AR navigation service, performing step 1016.

Step 1015, displaying a dual-entry pop-up window for graphic guidance and AR guidance.

Specifically, the interface of the electronic device may display the dual-entry pop-up window for the graphic guidance and AR guidance shown in FIG. 6.

The interface of the electronic device may display the graphic-text guidance pop-up window as shown in FIG. 7. The interface of the electronic device may display the AR guidance pop-up window as shown in FIG. 8.

Step 1016, displaying a graphic-text guidance pop-up window.

Specifically, the interface of the electronic device may display the graphic-text guidance pop-up window as shown in FIG. 7.

Through some embodiments of the present disclosure, the electronic device may display all the pick-up areas. A user may freely choose the target pick-up location without being forcibly recommended to a target pick-up location, which increases the diversity of choices. At the same time, since the user may independently select the pick-up area, the interaction efficiency between the electronic device and the user on the side of the electronic device may be improved, and the user experience may be improved.

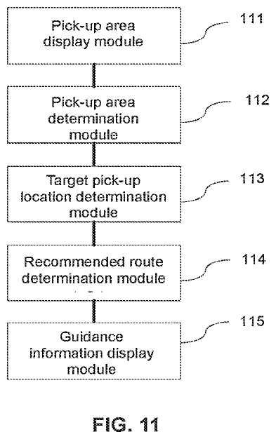

Based on the same technical concept, some embodiments of the present disclosure may also provide an information interaction apparatus. As shown in FIG. 11, the apparatus may include: a pick-up area display module 111, a pick-up area determination module 112, a target pick-up location determination module 113, a recommended route determination module 114, and a guidance information display module 115.

The pick-up area display module 111 may be configured to, in response to monitoring that an expected pick-up location is within a preset coordinate range, display at least one pick-up area within the preset coordinate range. The expected pick-up location may be a coordinate point of a map.

The pick-up area determination module 112 may be configured to receive a pick-up area selecting instruction, and determine a target pick-up area.

The target pick-up location determination module 113 may be configured to determine a target pick-up location corresponding to the target pick-up area.

The recommended route determination module 114 may be configured to determine a recommended route between a current location and the target pick-up location in response to receiving a submitting instruction for the target pick-up location.

The guidance information display module 115 may be configured to display route guidance information based on the recommended route.

Optionally, each of the at least one pick-up area may include at least one pick-up sub-area.

The pick-up area display module 111 may be configured to:

Display the at least one pick-up area within the preset coordinate range and the at least one pick-up sub-area in each pick-up area.

Optionally, the pick-up area display module 111 may be further configured to:

display the preset coordinate range in a map area of a display interface, and display the at least one pick-up area and the at least one pick-up sub-area in each pick-up area in a list area of the display interface.

Optionally, the pick-up area display module 111 may be further configured to:

render the at least one pick-up sub-area in each pick-up area with a preset color and display the rendered at least one pick-up area on the map area of the display interface.

Optionally, the target pick-up location determination module may be configured to:

receive a pick-up sub-area selecting instruction, and determine a target pick-up sub-area;

determine at least one to-be-determined pick-up location corresponding to the target pick-up area;

determine a target pick-up location in the at least one to-be-determined pick-up location.

Optionally, the target pick-up location determination module 113 may be further configured to:

in response to the target pick-up sub-area having one to-be-determined pick-up location, determine that the to-be-determined pick-up location is the target pick-up location;

in response to the target pick-up sub-area having multiple to-be-determined pick-up locations, determine one to-be-determined pick-up location of the multiple to-be-determined pick-up locations as the target pick-up location.

Optionally, the target pick-up location determination module 113 may be further configured to:

determine a passenger flow density of each to-be-determined pick-up location, wherein the passenger-flow density is used to characterize a count of people waiting to be picked up at the to-be-determined pick-up location;

determine a to-be-determined pick-up location with a smallest passenger flow density as the target pick-up location.

Optionally, the guidance information display module 115 may be configured to perform at least one of:

based on the recommended route, displaying a graphic-text walking guidance information window on the display interface, wherein the graphic-text walking guidance information window includes text guidance information and image guidance information;

based on the recommended route, displaying an augmented reality walking guidance window on the display interface, wherein the augmented reality walking guidance window includes an environment image collected in real-time by a terminal and a guidance sign rendered and displayed on the environment image; or

based on the recommended route, displaying a guide window for service usage of a pick-up personnel at airport, wherein the guide window for the service usage of the pick-up personnel at airport includes appearance description information of the pick-up personnel and location information of the pick-up personnel.

Through some embodiments of the present disclosure, the electronic device may display all pick-up areas. A user may freely choose the target pick-up location without being forcibly recommended to a target pick-up location, which increases the diversity of choices. At the same time, since the user may independently select the pick-up area, the interaction efficiency between the electronic device and the user on the side of the electronic device may be improved, and the user experience may be improved.

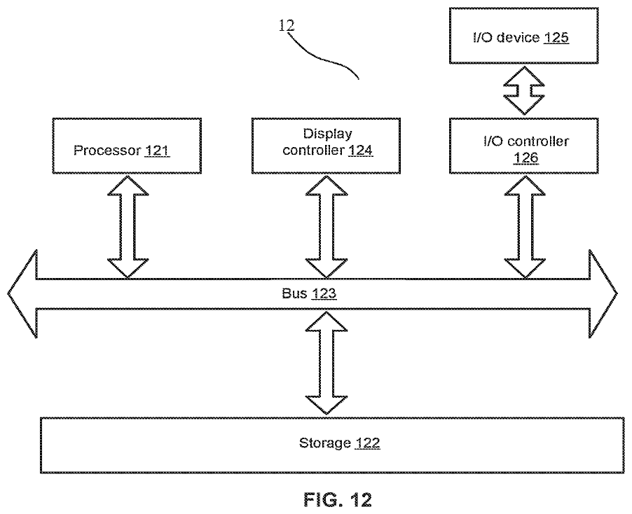

FIG. 12 is a schematic diagram illustrating a structure of an electronic device according to some embodiments of the present disclosure. As shown in FIG. 12, the electronic device shown in FIG. 12 may be a general address query device. The electronic device may include a general computer hardware structure, which at least includes a processor 121 and a storage 122. The processor 121 and the storage 122 may be connected via a bus 123. The storage 122 may be adapted to store instructions or programs executable by the processor 121. The processor 121 may be an independent microprocessor, or a set of one or more microprocessors. Thus, the processor 121 may execute the instructions stored in the storage 122 to execute the above-described method flow of some embodiments of the present disclosure to process data and control other devices. The bus 123 may connect the above-described various components together, and connect the above-described components to a display controller 124, a display device, and an input/output (I/O) device 125. The input/output (I/O) device 125 may be a mouse, a keyboard, a modem, a network interface, a touch input device, a somatosensory input device, a printer, or other devices known in the art. Typically, the input/output device 125 may be connected to the system through an input/output (I/O) controller 126.

It should be understood by those skilled in the art that some embodiments of the present disclosure may be provided as a method, an apparatus (device), or a computer program product. Accordingly, the present disclosure may use a full hardware embodiment, a full software embodiment, or a combination of software and hardware embodiments. Furthermore, the present disclosure may employ a computer program product implemented on one or more computer-readable storage media (including, but being not limited to, a disk storage, a CD-ROM, an optical storage, etc.) having computer-usable program codes embodied therein.

The present disclosure may be described with reference to flowchart illustrations of a method, an apparatus (device), and a computer program product according to embodiments of the present disclosure. It should be understood that each process in the flowcharts may be implemented by computer program instructions.

These computer program instructions may be stored in a computer readable storage capable of directing a computer or other programmable data processing device to function in a particular manner, such that the instructions stored in the computer readable storage result in a manufacture product comprising an instruction apparatus. The instruction apparatus may implement the functions specified in one flow or multiple flows of the flowchart.

These computer program instructions may also be provided to a processor of a general purpose computer, a special purpose computer, an embedded processor, or other programmable data processing devices to produce a machine, such that instructions executed by the processor of the computer or other programmable data processing devices may produce an apparatus for implementing the functions specified in a flow or flows of the flowchart.

Another embodiment of the present disclosure may relate to a non-volatile storage medium for storing a computer-readable program. The computer-readable program may be used for a computer to execute some or all of the above method embodiments.

That is, those skilled in the art may understand that all or part of the steps in the method of the above-mentioned embodiments may be completed by instructing relevant hardware through a program. The program may be stored in a storage medium, and include several instructions to make a device (e.g., a single chip microcomputer, a chip, etc.) or a processor to execute all or part of the steps of the methods described in the embodiments of this present disclosure. The aforementioned storage medium may include: a U disk, a mobile hard disk, a Read-Only Memory (ROM), a Random Access Memory (RAM), a magnetic disk, an optical disk, and other media that can store program codes.

The above descriptions are only preferred embodiments of the present disclosure, and are not intended to limit the present disclosure. For those skilled in the art, the present disclosure may have various modifications and changes. Any modification, equivalent replacement, improvement, etc., made within the spirit and principle of this present disclosure shall be included within the protection scope of this present disclosure.

1. An information interaction method, comprising:
in response to monitoring that an expected pick-up location is within a preset coordinate range, displaying at least one pick-up area within the preset coordinate range, wherein the expected pick-up location is a coordinate point of a map;
receiving a pick-up area selecting instruction, and determining a target pick-up area;
determining a target pick-up location corresponding to the target pick-up area;
determining a recommended route between a current location and the target pick-up location in response to receiving a submitting instruction for the target pick-up location; and
based on the recommended route, displaying route guidance information.

2. The method of claim 1, wherein each of the at least one pick-up area includes at least one pick-up sub-area;
the displaying the at least one pick-up area within the preset coordinate range includes:
displaying the at least one pick-up area within the preset coordinate range and the at least one pick-up sub-area in each pick-up area.

3. The method of claim 2, wherein the displaying the at least one pick-up area within the preset coordinate range and the at least one pick-up sub-area in each pick-up area includes:
displaying the preset coordinate range in a map area of a display interface, and
displaying the at least one pick-up area and the at least one pick-up sub-area in each pick-up area in a list area of the display interface.

4. The method of claim 3, wherein the displaying the preset coordinate range in the map area of the display interface includes:
rendering the at least one pick-up sub-area in each pick-up area with a preset color and displaying the rendered at least one pick-up sub-area on the map area of the display interface.

5. The method of claim 1, wherein the determining the target pick-up location corresponding to the target pick-up area includes:
receiving a pick-up sub-area selecting instruction, and determining a target pick-up sub-area;
determining at least one to-be-determined pick-up location corresponding to the target pick-up area; and
determining the target pick-up location in the at least one to-be-determined pick-up location.

6. The method of claim 5, wherein the determining the target pick-up location in the at least one to-be-determined pick-up location includes:
in response to the target pick-up sub-area having one to-be-determined pick-up location, determining that the to-be-determined pick-up location is the target pick-up location; or
in response to the target pick-up sub-area having multiple to-be-determined pick-up locations, determining one to-be-determined pick-up location of the multiple to-be-determined pick-up locations as the target pick-up location.

7. The method of claim 6, wherein the determining one to-be-determined pick-up location of the multiple to-be-determined pick-up locations as the target pick-up location includes:
determining a passenger flow density of each of the multiple to-be-determined pick-up locations, wherein the passenger-flow density is used to characterize a count of people waiting to be picked up at the to-be-determined pick-up location; and
determining a to-be-determined pick-up location with a smallest passenger flow density as the target pick-up location.

8. The method of claim 1, wherein the displaying the route guidance information based on the recommended route includes at least one of:
based on the recommended route, displaying a graphic-text walking guidance information window on a display interface, wherein the graphic-text walking guidance information window includes text guidance information and image guidance information;
based on the recommended route, displaying an augmented reality walking guidance window on a display interface, wherein the augmented reality walking guidance window includes an environment image collected in real-time by a terminal and a guidance sign rendered and displayed on the environment image; or
based on the recommended route, displaying a guidance window for service usage of a pick-up personnel at airport, wherein the guidance window for the service usage of the pick-up personnel at airport includes appearance description information of the pick-up personnel and location information of the pick-up personnel.

9-16. (canceled)

17. An electronic device comprising a storage and a processor, wherein the storage is configured to store one or more computer program instructions, and the one or more computer program instructions are executed by the processor to implement a method comprising:
receiving a pick-up area selecting instruction, and determining a target pick-up area;
determining a target pick-up location corresponding to the target pick-up area;
determining a recommended route between a current location and the target pick-up location in response to receiving a submitting instruction for the target pick-up location; and
based on the recommended route, displaying route guidance information.

18. A non-transitory computer-readable storage medium,
comprising a set of instructions, wherein when executed by a processor, a method is implemented, the method comprising:
receiving a pick-up area selecting instruction, and determining a target pick-up area;
determining a target pick-up location corresponding to the target pick-up area;
determining a recommended route between a current location and the target pick-up location in response to receiving a submitting instruction for the target pick-up location; and
based on the recommended route, displaying route guidance information.

19. The electronic device of claim 17, wherein each of the at least one pick-up area includes at least one pick-up sub-area;
the displaying the at least one pick-up area within the preset coordinate range includes:
displaying the at least one pick-up area within the preset coordinate range and the at least one pick-up sub-area in each pick-up area.

20. The electronic device of claim 19, wherein the displaying the at least one pick-up area within the preset coordinate range and the at least one pick-up sub-area in each pick-up area includes:
displaying the preset coordinate range in a map area of a display interface, and
displaying the at least one pick-up area and the at least one pick-up sub-area in each pick-up area in a list area of the display interface.

21. The electronic device of claim 20, wherein the displaying the preset coordinate range in the map area of the display interface includes:
rendering the at least one pick-up sub-area in each pick-up area with a preset color and displaying the rendered at least one pick-up sub-area on the map area of the display interface.

22. The electronic device of claim 17, wherein the determining the target pick-up location corresponding to the target pick-up area includes:
receiving a pick-up sub-area selecting instruction, and determining a target pick-up sub-area;
determining at least one to-be-determined pick-up location corresponding to the target pick-up area; and
determining the target pick-up location in the at least one to-be-determined pick-up location.

23. The electronic device of claim 22, wherein the determining the target pick-up location in the at least one to-be-determined pick-up location includes:
in response to the target pick-up sub-area having one to-be-determined pick-up location, determining that the to-be-determined pick-up location is the target pick-up location; or
in response to the target pick-up sub-area having multiple to-be-determined pick-up locations, determining one to-be-determined pick-up location of the multiple to-be-determined pick-up locations as the target pick-up location.

24. The electronic device of claim 23, wherein the determining one to-be-determined pick-up location of the multiple to-be-determined pick-up locations as the target pick-up location includes:
determining a passenger flow density of each of the multiple to-be-determined pick-up locations, wherein the passenger-flow density is used to characterize a count of people waiting to be picked up at the to-be-determined pick-up location; and
determining a to-be-determined pick-up location with a smallest passenger flow density as the target pick-up location.

25. The electronic device of claim 17, wherein the displaying the route guidance information based on the recommended route includes at least one of:
based on the recommended route, displaying a graphic-text walking guidance information window on a display interface, wherein the graphic-text walking guidance information window includes text guidance information and image guidance information,
based on the recommended route, displaying an augmented reality walking guidance window on a display interface, wherein the augmented reality walking guidance window includes an environment image collected in real-time by a terminal and a guidance sign rendered and displayed on the environment image; or
based on the recommended route, displaying a guidance window for service usage of a pick-up personnel at airport, wherein the guidance window for the service usage of the pick-up personnel at airport includes appearance description information of the pick-up personnel and location information of the pick-up personnel.

26. The non-transitory computer-readable storage medium of claim 18, wherein each of the at least one pick-up area includes at least one pick-up sub-area;
the displaying at least one pick-up area within the preset coordinate range includes:
displaying the at least one pick-up area within the preset coordinate range and the at least one pick-up sub-area in each pick-up area.

27. The non-transitory computer-readable storage medium of claim 26, wherein the displaying the at least one pick-up area within the preset coordinate range and the at least one pick-up sub-area in each pick-up area includes:
displaying the preset coordinate range in a map area of a display interface, and displaying the at least one pick-up area and the at least one pick-up sub-area in each pick-up area in a list area of the display interface.

28. The non-transitory computer-readable storage medium of claim 27, wherein the displaying the preset coordinate range in the map area of the display interface includes:
rendering the at least one pick-up sub-area in each pick-up area with a preset color and displaying the rendered at least one pick-up sub-area on the map area of the display interface.
